(19) United States
(12) Patent Application Publication
(10) Pub. No.: US 2012/0131017 A1
(43) Pub. Date: May 24, 2012

(54) TAG INFORMATION MANAGEMENT APPARATUS, TAG INFORMATION MANAGEMENT SYSTEM, COMPUTER READABLE MEDIUM, AND TAG INFORMATION MANAGEMENT METHOD

(75) Inventors: Hayato Kato, Nagoya-shi (JP); Hiroaki Kawasaki, Nagoya-shi (JP); Yutaka Maruyama, Nagoya-shi (JP); Kenji Takahashi, Nagoya-shi (JP)

(73) Assignee: Buffalo Inc., Nagoya-shi (JP)

(21) Appl. No.: 13/282,723

(22) Filed: Oct. 27, 2011

(30) Foreign Application Priority Data
Oct. 27, 2010 (JP) 2010-241258

(51) Int. Cl. G06F 17/30

(52) U.S. Cl. 707/748; 707/E17.058

(57) ABSTRACT

A tag information management apparatus for managing tag information indicative of an attribute relating to content data, comprising: an extraction unit that extracts existing tag information assigned to the content data; a generation unit that generates new tag information associated with the existing tag information extracted by the extraction unit; and an assignment unit that assigns the new tag information generated by the generation unit to the content data.

### CROSS REFERENCE TO RELATED APPLICATIONS

This application is based upon and claims the benefit of priority from prior Japanese Patent Application No. 2010-241258, filed on Oct. 27, 2010; the entire content of which is incorporated herein by reference.

### BACKGROUND OF THE INVENTION

1. Field of the Invention

The present invention relates to a tag information management apparatus, a tag information management system, a computer readable medium, and a tag information management method, for managing tag information indicative of an attribute relating to content data.

2. Description of the Related Art

In recent years, with the spread of lower priced recording mediums or the like, users hold content data such as a large amount of image data, voice data, or document data. Thus, appropriate management of a large amount of content data is required.

For example, the Description of JP-A-2004-312244 discloses a method of collectively recording acquired image indicating a same attribute in one recording folder, which facilitates management of the acquired image.

However, in a case where the technique described in the abovementioned JP-A-2004-312244 is employed as well, if an attempt is made to add an attribute of an acquired image in order to perform management more appropriately, it is obliged to be dependent on manpower, and is cumbersome.

### SUMMARY OF THE INVENTION

A first feature of the present invention is summarized as a tag information management apparatus (set top box 10) for managing tag information indicative of an attribute relating to content data, comprising: an extraction unit (existing tag information extraction unit 154) that extracts existing tag information assigned to the content data; a generation unit (new tag information generation unit 156) that generates new tag information associated with the existing tag information extracted by the extraction unit; and an assignment unit (new tag information assignment unit 158) that assigns the new tag information generated by the generation unit to the content data.

Such a tag information management apparatus extracts existing tag information assigned to content data, generates new tag information associated with the existing tag information, and adds the generated new tag information to the content data. Therefore, addition of tag information indicative of an attribute relating to the content data is facilitated.

The feature of the present invention is summarized as that the generation unit generates the new tag information, based on the existing tag information and user information.

The feature of the present invention is summarized as that the generation unit generates the new tag information, based on user information of a user specified by means of image recognition processing based on the image data, in a case where the content data is image data.

The feature of the present invention is summarized as that the generation unit acquires first association information associated with the image data, based on the existing tag information, and then, generates the new tag information, based on the first association information.

The feature of the present invention is summarized as that the generation unit acquires second association information obtained by means of image recognition processing based on the image data and associated with the image data, in a case where the content data is image data, and then, generates the new tag information, based on the second association information.

A feature of the present invention is summarized as a tag information management system for managing existing tag information assigned to the content data, comprising: an extraction unit that extracts existing tag information assigned to the content data; a generation unit that generates new tag information associated with the existing tag information extracted by the extraction unit; and an assignment unit that assigns the new tag information generated by the generation unit to the content data.

A feature of the present invention is summarized as a computer readable medium storing a program for managing tag information indicative of an attribute relating to content data, wherein the program cause a computer to perform the steps of: extracting existing tag information assigned to the content data; generating new tag information associated with the extracted existing tag information; and assigning the generated new tag information to the content data.

A feature of the present invention is summarized as a tag information management method in a tag information management apparatus for managing tag information indicative of an attribute relating to content data, comprising the steps of: extracting existing tag information assigned to the content data; generating new tag information associated with the extracted existing tag information; and assigning the generated new tag information to the content data.

### BRIEF DESCRIPTION OF THE DRAWINGS

FIG. 1 is a structural view of a set top box according to an embodiment of the present invention.

FIG. 2 is a view showing a structure of image data according to the embodiment of the present invention.

FIG. 3 is a view showing one example of user information.

FIG. 4 is a view showing one example of landmark event information.

FIG. 5 is a view showing one example of generation of new tag information.

FIG. 6 is a flowchart showing an operation of the set top box according to the embodiment of the present invention.

FIG. 7 is an entire schematic structural view of a content management system according to another embodiment of the present invention.

### DETAILED DESCRIPTION OF THE EMBODIMENTS

Next, the embodiments of the present invention will be described with reference to the drawings. Specifically, (1) a structure of a set top box and (2) an operation of the set top box, (3) functions and advantageous effects, and (4) other embodiments will be described. In the description of the drawings in the following embodiments, the same or similar constituent elements are designated by the same or similar reference numerals.

### (1) Structure of Set Top Box

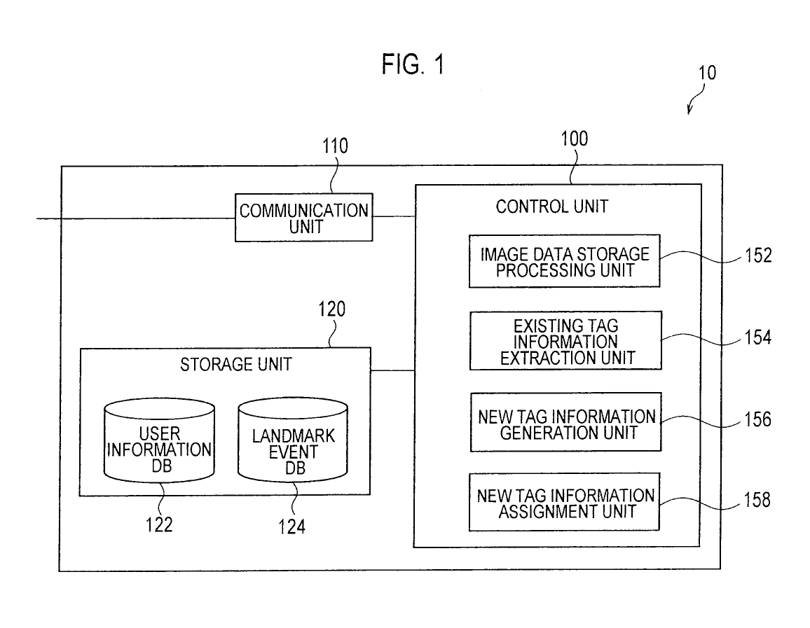

FIG. 1 is a structural view of a set top box 10 as a content management apparatus. The set top box 10 shown in FIG. 1 manages image data transmitted from a digital camera which is an external device, although not shown. The set top box 10 contains a control unit 100, a communication unit 110, and a storage unit 120.

The control unit 100 is formed of a CPU, for example, and controls a variety of functions included in the set top box 10.

The communication unit 110 is a LAN card, for example, and a MAC (Media Access Control) address is assigned to the LAN card. The communication unit 110 is a communication interface that makes communication with an external device, and makes communication with an external communication apparatus via a communication network. The storage unit 120 is formed of a NAND flash memory, for example, and stores a variety of information employed for control or the like in the set top box 10.

The control unit 100 contains an image data storage processing unit 152, an existing tag information extraction unit 154, a new tag information generation unit 156, and a new tag information assignment unit 158.

The image data storage processing unit 152 receives via the communication unit 110 image data as content data transmitted from a digital camera. Further the image data storage processing unit 152 stores the received image data in a storage unit 120.

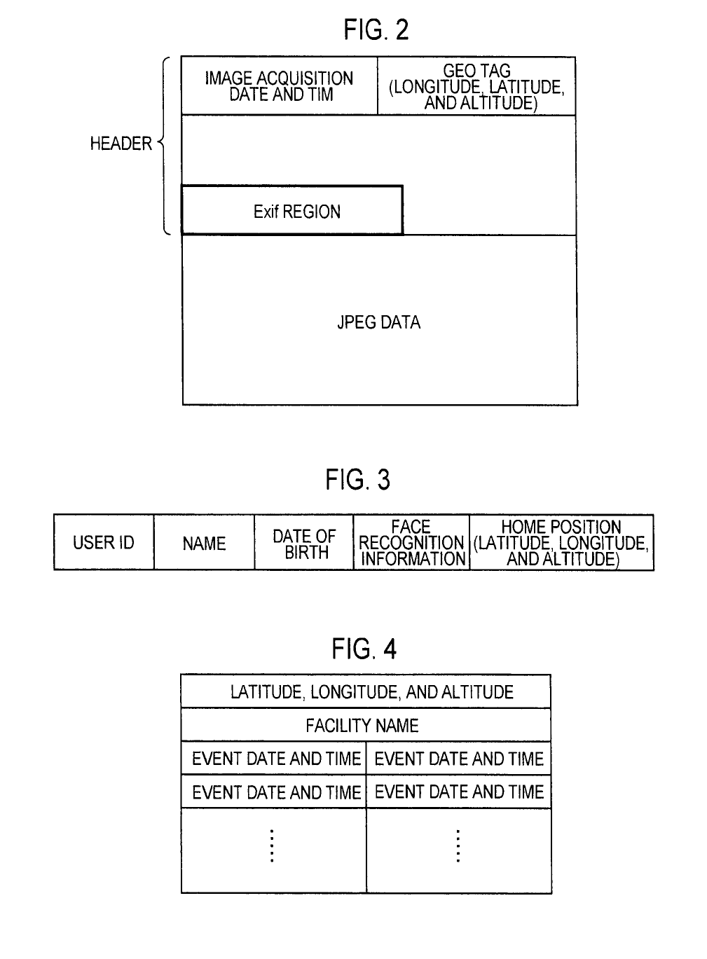

FIG. 2 is a view showing a structure of image data. The image data shown in FIG. 2 is formed of a header and JPEG (Joint Photographic Experts Group) data.

The header includes existing tag information indicative of an attribute of image data. The existing tag information is information indicative of an attribute of image data to be assigned at the time of image acquisition by means of a digital camera. In the embodiment, the existing tag information is information on date and time of image acquisition and information on a latitude, a longitude, and an altitude of an image acquisition position (a Geo Tag).

In addition, the header includes an Exif (Exchangeable image file format) region. The Exif region includes new tag information to be described later.

A description will be given turning to FIG. 1 again. The existing tag information extraction unit 154 extracts existing tag information from the image data stored in the storage unit 120.

The new tag information generation unit 156 generates new tag information other than the existing tag information (hereinafter, simply referred to as new tag information). Specifically, the new tag information generation unit 156 generates new tag information as follows.

The new tag information generation unit 156 reads out from image data from the storage unit 120. The new tag information generation unit 156 performs image recognition processing. The image recognition processing used herein is at least any of specifying a user which is a photographic subject, specifying a character string included in an image corresponding to image data; and specifying a scene of the user which is the photographic subject. As to specifying the user which is the photographic subject, the new tag information generation unit 156 may specify a predetermined user, for example, without being limitative to image recognition processing.

In a case of specifying the user which is the photographic subject, the new tag information generation unit 156 reads out user information stored in a user information DB (Data Base) 122 in the storage unit 120.

FIG. 3 is a view showing one example of the user information stored in the user information DB in the storage unit 120. The user information shown in FIG. 3 includes: a user ID which is identification information of the user; a name of the user; a date of birth of the user; face recognition information of the user; and a home position (a latitude, a longitude, and an altitude) of the user. The face recognition information is information indicative of features of a user's face.

The new tag information generation unit 156 extracts face recognition information from each of the read out items of user information. The new tag information generating unit 156 specifies the user which is the photographic subject of an image that corresponds to image data, based on each of the extracted items of face recognition information and the image data. In a case where no photographic subject exists, for example, in a case where only a scene has been acquired as an image, the new tag information generation unit 156 does not specify the user which is the photographic subject.

In a case where the user which is the photographic subject has been specified, the new tag information generation unit 156 extracts a date of birth in user information that corresponds to the user. The new tag information generation unit 156 computes an age of the user which is the photographic subject, based on the extracted date of birth and a current year, month, and day.

In addition, the new tag information generation unit 156 specifies: a facility that corresponds to a latitude, a longitude, and an altitude, each of which is indicated by a geo tag included in the existing tag information; and an event to be performed at a given date and time included in the existing tag information.

FIG. 4 is a view showing one example of landmark event information stored in the landmark event information DB 124 in the storage unit 120. The landmark even information shown in FIG. 4 is provided in each facility, and the landmark event information: the latitude, the longitude, and the altitude of the facility; and a facility name of the facility. In addition, the landmark event information includes: an event date and time; and a name of the event to be performed in the facility at the event date and time. The control unit 100 updates the landmark event information DB 124 anytime by means of search or the like in the Internet, for example.

The new tag information generation unit 156 determines whether or not there exists landmark event information (for example, that is a different of several meters) of which latitude, longitude, and altitude are coincident to or approximate the latitude, the longitude, and the altitude that are indicated by geo tag, from among the items of lamp event information. The landmark event information of which latitude, longitude, and altitude are coincident to or approximate the latitude, the longitude, and the altitude that are indicated by geo tag included in the existing tag information is landmark event information that corresponds to a facility that exists at a position at which an image corresponding to image data has been acquired (hereinafter, simply referred to as landmark event information that corresponds to an image acquisition position).

In a case where there exists the landmark event information that corresponds to an image acquisition position, the new tag information generation unit 156 determines whether or not any duplication with the acquisition date and time included in the existing tag information exists from among the event dates and times that are included in the landmark event information that corresponds to the image acquisition position. In a case where there exists an event date and time duplicated with the image acquisition date and time included in the existing tag information, the new tag information generation unit 156 extracts: a facility name included in the landmark event information that corresponds to the image acquisition position; and an event name that corresponds to the event date and time duplicated with the image acquisition date and time included in the existing tag information. The extracted facility name is a name of a facility that exists at a position at which an image corresponding to image data has been acquired, and the extracted event name is a name of an event that has been performed in the facility at the image acquisition date and time.

Next, the new tag information generation unit 156 generates new tag information, based on information that could be acquired by means of the processing operations described above, from among a variety of information such as the image acquisition date and time included in the existing tag information, a geo tag included in the existing tag information, the name of a user which is a photographic subject, the date of birth of the user which is the photographic subject, the age of the user which is the photographic subject, the character string included in an image; a home position of the user which is the photographic subject, a scene of the image, the facility name, and the event name.

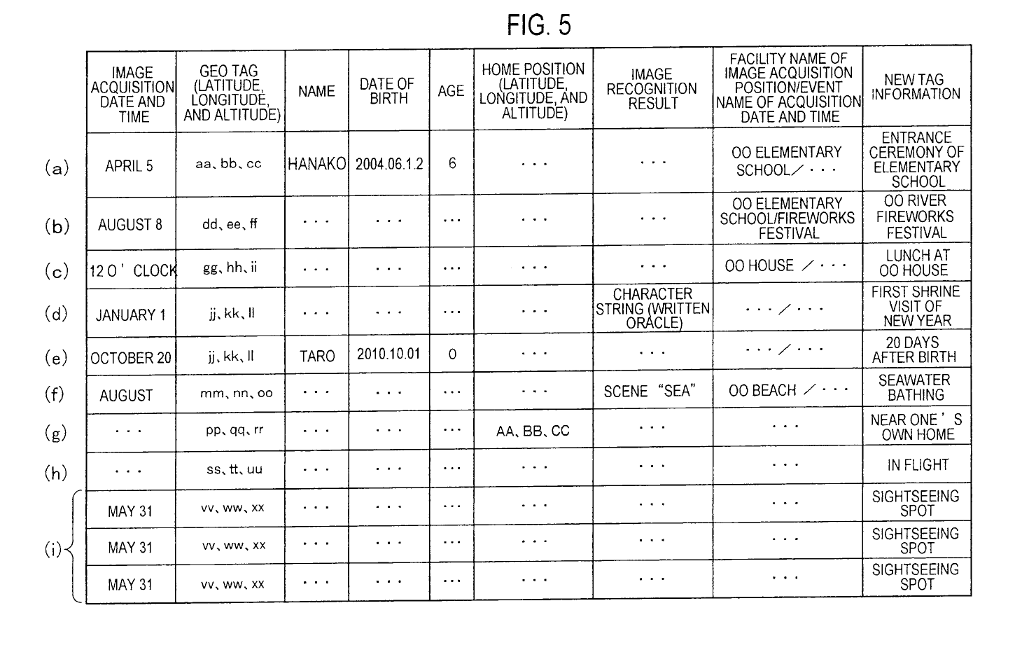

FIG. 5 is a view showing one example of generation of new tag information.

In the case of FIG. 5 (a), the new tag information generation unit 156 acquires “April 5”, which is an acquisition date and time which is an item of the existing tag information; a geo tag which is an item of the existing tag information; “Hanako”, which is a name of a user which is a photographic subject; “Jun. 12, 2004”, which is a date of birth of the user which is the photographic subject; “6”, which is an age of the user which is the photographic subject; and “OO Elementary School”, which is a name of a facility at an acquisition position. In this case, the new tag information generation unit 156 estimates that the corresponding image data is associated with an entrance ceremony of the elementary school, since the image acquisition date and time which is an item of the existing tag information is “April 5”; the age of the user which is the photographic subject is “6”; and the name of the facility at the image acquisition position is “OO Elementary School”. Further, the new tag information generation unit 156 generates “an entrance ceremony of the elementary school”, which is an item of new tag information according to an estimation result. The new tag information generation unit 156 generates the “OO Elementary School” which is the facility name at the image acquisition name, as an item of new tag information, without performing the abovementioned estimation.

In the case of FIG. 5 (b), the new tag information generation unit 156 acquires: “August 8”, which is an image acquisition date and time which is the existing tag information; a geo tag which is an item of the existing tag information; “OO River”, which is a facility name at an image acquisition position; and “Fireworks Festival”, which is an event of the image acquisition date and time. In this case, the new tag information generation unit 156 generates new tag information “OO River Fireworks Festival” obtained by combining the “OO River”, which is the name of the facility name at the image acquisition position, and the “Fireworks Festival”, which is the event of the image acquisition date and time.

In the case of FIG. 5 (c), the new tag information generation unit 156 acquires: “12:00”, which is an image acquisition date and time which is an item of the existing tag information; a geo tag which is an item of the existing tag information; and “OO House”, which is a name of a facility at an acquisition position. In this case, the new tag information generation portion 156 estimates that the corresponding image data is associated with a lamp, since the image acquisition date and time is “12:00” and the name of the facility at the image acquisition position is “OO House”. For example, the new tag information generation unit 156 generates “OO House lunch”, which is an item of new tag information according to an estimation result. The new tag information generation unit 156 may generate “00 House”, which is the name of the facility at the image acquisition position, as an item of new tag information.

In the case of FIG. 5 (d), the new tag information generation unit 156 acquires: “January 1”, which is an image acquisition date and time which is an item of the existing tag information; a geo tag which is an item of the existing tag information; and a “written oracle”, which is a character string included in an image. In this case, the new tag information generation unit 156 estimates that the corresponding image data is associated with a first shrine visit of a new year, since the image acquisition date and time which is an item of the existing tag information is “January 1” and the character string included in the image is the “written oracle”. Further, the new tag information generation portion 156 generates the first shrine visit of a new year, which is an item of new tag information according to an estimation result.

In the case of FIG. 5 (e), the new tag information generation unit 156 acquires: “October 20”, which is an image acquisition date and time which is an item of the existing tag information; a geo tag which is an item of the existing tag information; “Taro”, which is a name of a user which is a photographic subject; “Oct. 1, 2010”, which is a date of birth of the user which is the photographic subject; and “0”, which is an age of the user which is the photographic subject. In this case, the new tag information generation unit 156 estimates that the corresponding image data is associated with a 20^{th} day after birth, since the image acquisition date and time which is an item of the existing tag information is “August 1” and the date of birth of the user which is the photographic subject is “Oct. 1, 2010”. Further, the new tag information generation portion 156 generates “20 days after birth”, which is an item of new tag information according to an estimation result.

In the case of FIG. 5 (f), the new tag information generation unit 156 acquires: “August”, which is an image acquisition date and time which is an item of the existing tag information; a “sea”, which is a scene of an image; and “OO Beach”, which is a name of a facility at an image acquisition position. In this case, the new tag information generation unit 156 estimates that the corresponding image data is associated with seawater bathing, since the image acquisition date and time which is an item of the existing tag information is “August” and the scene of the image is the “sea”. Alternatively, the new tag information generation unit 156 estimates that the corresponding image data is associated with seawater bathing, since the image acquisition date and time included in the existing tag information is “August” and the name of the facility at the image acquisition position is “OO Beach”. Further, the new tag information generation unit 156 generates the “seawater bathing”, which is an item of new tag information according to an estimation result.

In the case of FIG. 5 (g), the new tag information generation unit 156 acquires a geo tag, which is an item of the existing tag information, and a home position. In this case, the new tag information generation unit 156 computes a distance between an image acquisition position indicated by the geo tag and the home position, and generates “near home”, which is an item of new tag information, in a case where the distance is within a predetermined value.

In the case of FIG. 5 (h), the new tag information generation unit 156 acquires a geo tag which is the existing tag information. In this case, the new tag information generation unit 156 generates “in flight”, which is an item of new tag information, in a case where the altitude in the geo tag is a predetermined value or more.

In the case of FIG. 5 (i), the new tag information generation unit 156 acquires an image acquisition date and time and a geo tag, each of which is an item of the existing tag information, as to three items of image data. In this case, in a case where there exists a predetermined number or more of image data corresponding to a same image acquisition date and time and a same geo tag (for example, in a case where three or more items of image data exist), the new tag information generation unit 156 generates a “sightseeing spot” with respect to a respective one of the image data corresponding to the same image acquisition date and time and the same geo tag.

A description will be given turning to FIG. 1 again. The new tag information assignment unit 158 acquires new tag information generated by means of the new tag information generation unit 156 to image data. Specifically, the new tag information assignment unit 158 writes new tag information into an Exif region at a header portion of the image data shown in FIG. 2.

### (2) Operation of Set Top Box

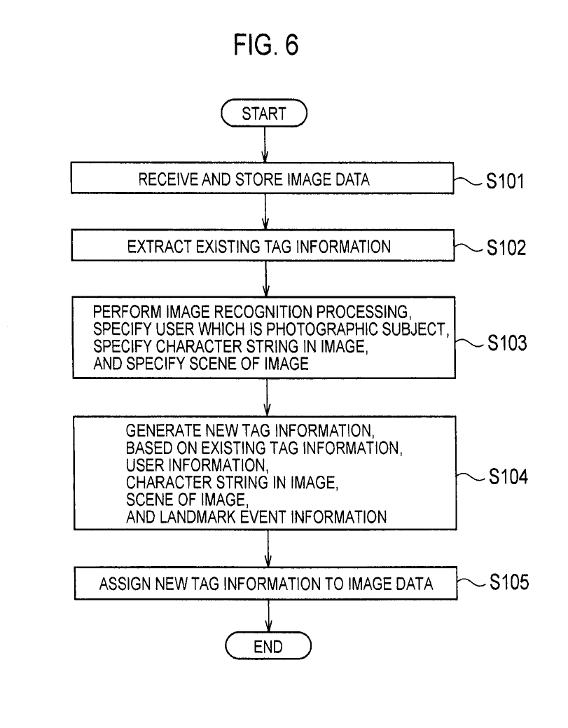

FIG. 6 is a flowchart showing an operation of the set top box 10.

In step S101, the set top box 10 receives and stores image data transmitted from a digital camera.

In step S102, the set top box 10 extracts the exiting tag information included in image data.

In step S103, the set top box 10 performs image recognition processing, specifies a user which is a photographic subject, specifies a character string in an image corresponds to image data, and specifies a scene of the image that corresponds to the image data.

In step S104, the set top box 10 specifies user information and the character sprint in the image that corresponds to the image data, and generates new tag information, based on a scene of the image that corresponds to the image data and landmark event information.

In step S105, the set top box 10 assigns the new tag information to the image data.

### (3) Functions and Advantageous Effects

The set top box 10 of the embodiment extracts existing tag information assigned to the image data, and generates new tag information associated with the existing tag information. For example, the set top box 10 reconizes an event that were implemented at an image acquisition date and time in a facility at an image acquisition position, based on the image acquisition date and time or a geo tag, each of which is the existing tag information, and utilizes the recognized event to generate new tag information. In addition, the set top box 10 recognize a user which is a photographic subject by means of image recognition processing, and utlizes information of the recognized user to generate new tag. Further, the set top box 10 assigns the generated new tag inrformation to the image data. Therefore, addition of tag information is facilitated and management of image data based on the tag informatin is also facilitated.

### (4) Other Embodiments

As described above, while the present invention was described by way of embodiment, it should not be understood that the discussion and drawings formimg a part of this disclosure limits the invention. From this disclosure, a variety of substitutive embodiments, examples, and operational techniques would have been self-evident to one skilled in the art.

While the foregoing embodiments described that the set top box 10 performs, in a stand alone manner, extraction of the existing tag information from image data, generation of new tag information, and addition of the new tag information to the image data. However, these processing operations may be shared and performed by a pluralty of devices.

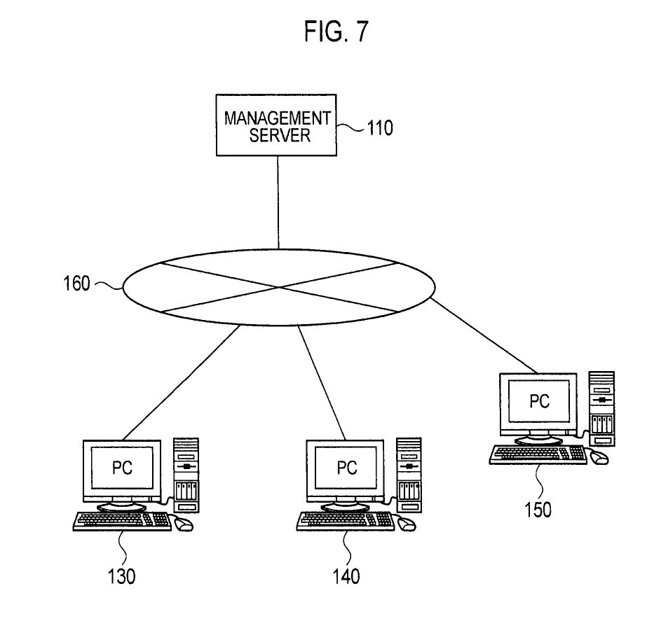

FIG. 7 is an entire schematic structura view of a content managememnt system. The content management system shown in FIG. 7 isformed of; a management server 110; a personal computer (PC) 130; a PC 140 and a PC 150; and a communication network 160 that connects the management server 110 and the PC 130 and the PC 150 to each other.

In the content management system of the embodiment, the management server 110 and the PC 130 to the PC 150 share and perform the processing operations of the image data stprage processing unit 152, the existing tag information extraction unit 154, the new tag information generation unit 156, and the new tag information assignment unit 158 in the control unit 100 of the set top box 10 shown in FIG. 1.

Specifically, a control unit of the PC 130 to the PC 150 performs the processing operations of the image data storage processing unit 152, the existing tag information extraction portion 154, and the new tag information assignment unit 158, and a control unit of the management server 110 includes the new tag information generation unit 156.

In this case, the image data storage processing unit 152 in the control unit of the PC 130 to the PC 150 receives image data and stores the received image data n a storage unit in the PC 130 to the PC 150.

The existing tag information extraction unit 154 in the control unit of the PC 130 to the PC 130 extracts the existing tag information from the image data stored in the storage unit. Further, the existing tag information extraction unit 154 in the control unit of the PC 130 to the PC 150 transmits the extracted existing tag infrormation to the management server 110 via the communication network 160.

Upon receipt of the transmitted existing tag information, the new tag information generation unit 156 in the control unit of the management server 110 generates new tag information, based on the existing tag information. Further, the new tag information generation unit 156 in the control unit of the management server 110 transmits the generated new tag inrforrmation to the PC 130 to the PC 150 via the communication network 160.

Upon receipt of the transmitted new tag information, the new tag information assignment unit 158 in the control unit of the PC 130 to the PC 150 assignes the received new tag information to the image data.

While the foregoing embodiments described a case in which image data is employed as content data, the present invention can also be applied similarly in a case where another item of content data such as voice data or document data is employed as well.

Althogh it is not shown in the foregoing embodiments, a program may be provided that causes a computer to perform respective steps shown in FIG. 6. The program may be recorded in a computer readable medium. According to the computer readable medium, the program may be installed in the computer, The computer readable medium storing the program may be a non-transitory recording medium. While it is not limitted, the non-transitory recording medium may be CD-ROM or DVD-ROM et al.

In this manner, it should be understood that the present invention encompasses a variety of embodiments or the like which is not described herein. Therefore, the present invention is limited only by specific matters of the invention of the claims that are reasonable from this disclosure.

What is claimed is:

1. A tag information management apparatus for managing tag information indicative of an attribute relating to content data, comprising:
an extraction unit that extracts existing tag information assigned to the content data;
a generation unit that generates new tag information associated with the existing tag information extracted by the extraction unit; and
an assignment unit that assigns the new tag information generated by the generation unit to the content data.

2. The tag information management apparatus according to claim 1, wherein
the generation unit generates the new tag information, based on the existing tag information and user information.

3. The tag information management apparatus according to claim 2, wherein
the generation unit generates the new tag information, based on user information of a user specified by means of image recognition processing based on the image data, in a case where the content data is image data.

4. The tag information management apparatus according to claim 1, wherein
the generation unit acquires first association information associated with the image data, based on the existing tag information, and then, generates the new tag information, based on the first association information.

5. The tag information management apparatus according to claim 1, wherein
the generation unit acquires second association information obtained by means of image recognition processing based on the image data and associated with the image data, in a case where the content data is image data, and then, generates the new tag information, based on the second association information.

6. A tag information management system for managing existing tag information assigned to the content data, comprising:
an extraction unit that extracts existing tag information assigned to the content data;
a generation unit that generates new tag information associated with the existing tag information extracted by the extraction unit; and
an assignment unit that assigns the new tag information generated by the generation unit to the content data.

7. A computer readable medium storing a program for managing tag information indicative of an attribute relating to content data, wherein
the program cause a computer to perform the steps of:
extracting existing tag information assigned to the content data;
generating new tag information associated with the extracted existing tag information; and
assigning the generated new tag information to the content data.

8. A tag information management method in a tag information management apparatus for managing tag information indicative of an attribute relating to content data, comprising the steps of:
extracting existing tag information assigned to the content data;
generating new tag information associated with the extracted existing tag information; and
assigning the generated new tag information to the content data.
